(19) United States
(12) Patent Application Publication
(10) Pub. No.: US 2010/0083122 A1
(43) Pub. Date: Apr. 1, 2010

(54) SYSTEMS, METHODS AND COMPUTER PRODUCTS FOR CONTROLLING MULTIPLE MACHINES USING A SEAMLESS USER-INTERFACE TO A MULTI-DISPLAY

(75) Inventors: James R. Kozloski, New Fairfield, CT (US); Charles C. Peck, Newton, CT (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/242,986

(22) Filed: Oct. 1, 2008

(51) Int. Cl. G06F 3/048; G06F 15/16

(52) U.S. Cl. 715/737

(57) ABSTRACT

Controlling multiple computers is accomplished by receiving signals, in a programmable computer implemented switch, from the multiple computers indicating a current position of a cursor displayed on a first display screen associated with a first computer of the multiple computers, where applications are being controlled on the first computer and accessible to a user. Signals from an input device transmitted to a programmable switch cause the cursor to change positions on the first display screen and as the cursor position approaches a boundary in between the first display screen and a second display screen associated with a second computer of the multiple computers, the cursor moves to the second display screen and the programmable switch automatically connects to the second computer, thus allowing the user to access and control applications executing on the second computer.

### FIELD OF THE INVENTION

This invention relates generally to networked computer system administration and management, software services, application solutions and data replication management directed to data handling programs, such as event monitoring in software management applications, data mining, pattern recognition, data analysis, data transcoding and data conversion operating in various operating system environments including Windows/PC and UNIX operating systems. More particularly, this invention relates to communications between and control of sets of sub displays and/or network computer displays configurable into a contiguous multi-display for use in the areas of storage management and optimization, reliability analysis and hardware configuration services. This invention can be applied to any system running any service provider application and/or operating system.

### BACKGROUND OF THE INVENTION

IBM® is a registered trademark of the International Business Machines Corporation, Armonk, N.Y., U.S.A. Other names used herein may be trademarks and registered trademarks, or trade or product names of International Business Machines Corporation or other companies.

### DESCRIPTION OF RELATED ART

Often a computer user is required to control multiple computers and/or machines with a single input device or a set of input devices, such as a mouse and a keyboard. Often a computer system is designed to provide a single output device for a user interface, such as a single display screen. Such configurations require a switch that the user toggles so as to switch the interface, such as the input or output device from one machine to another machine. A known switch, such as a keyboard/video/mouse (KVM) switch, can be used to switch the interface. The problem of controlling multiple displays with a single user interface is common to environments where a single user or administrator must use or maintain a large number of computers. For example, in an environment employing server farms, a single administrator must select from a large number of machines to administer at one time. In high technology and/or scientific work environments, a user may have two or more machines, one can be a more advanced multi-core workstation computer, another could be a massively parallel host computer for running experiments and/or simulations and/or performing intensive calculations and another machine can be used for performing day-to-day inter and intra-office communications, such as drafting e-mail communications or performing word processing tasks or creating spreadsheets. In any of these environments, including the routine office environment or the high technology and/or scientific environments, it is often desirable for the user to switch from one machine to another in order to perform various tasks. It is difficult to control two or more computers and switch seamlessly between the user interfaces of the two or more computers (i.e., switching between one computer's user interface to another computer's user interface). Known ways of accomplishing this include the user physically changing switch positions of a switch and switching from using one machine to using a different terminal containing all of the elements of the user interface devices, such as a keyboard, video monitor and/or mouse in duplicate. An alternative approach would be for the user to physically toggle a hardware switch, such as the KVM switch or an ABC switch box. Another approach includes positioning a laptop computer (which has its own monitor assembled as part of the laptop computer) next to a stand along desktop monitor, where a single operating system on the laptop computer is configured to control the stand alone desktop monitor, as well as the monitor assembled in the laptop computer. Thus, known systems are available for configuring a single machine running a single instance of a Windows operating system to produce video output to two displays. An application running in this operating system (such as Windows Remote Desktop Connection) may provide a user the ability to display another computer's user interface within the confines of this second display with an appropriate configuration of these components. These approaches require the computer user to break concentration and perform the transitioning task, i.e., switching from one machine to another machine manually or are limited to controlling one machine or one machine running an application that replicates the user interface from another machine configured by the user to exploit two displays.

Therefore, the need exists for a solution for computer users who want to use multiple computer implemented machines at the same time by redirecting a computer user interface from one computer implemented machine to another computer implemented machine by seamlessly switching control of each of the multiple computer implemented machines without breaking concentration or toggling a switch physically or having the computer user relocating physically from one position to another position or from one computer to another computer or using different user interfaces in order to control the multiple computers. Further, the need exists for providing a computer user with a trans-machine operating system capability by providing a unified and seamless user-interface to the user who is responsible for controlling multiple computer implemented machines.

### SUMMARY OF THE INVENTION

A method of controlling a first computer and a second computer comprising using a seamless user interface (such as a network interface, and/or a device driver, and/or a user interface, and/or a network node or an input/output interface of a plurality of interfaces, drivers or nodes) in a computer implemented system is accomplished by the operations of receiving, in an input switch, a first plurality of signals from the first computer and/or the second computer. In the exemplary embodiment, a cursor state monitor provides an indication of, for at least one signal of the first plurality of signals, the current position state of display and movement, i.e., moving and/or positioning of a cursor being rendered and displayed on either a first computer display screen or a second computer display screen. The first computer display screen and the second computer display screen are communicatively coupled to the first computer and the second computer respectively. The input switch may be an input switch module that resides in and/or is included in a network node or may be included in a computer. The input switch may be a programmable computer implemented switch module and receives a first input signal of the second plurality of signals from the one or more input devices, conveying cursor movement on a display screen. The first input signal from the second plurality of signals is relayed to either an application or operating system or display driver responsible for rendering the display properties of the cursor, in regard to the first or second computer display screens, in regard to an application running on the first computer or the second computer, i.e., a first application or a second application. The use of two displays is thus inherent to this exemplary embodiment and does not require user configuration. These signals are relayed to the standard and network computer systems, over a computer network to the standard, and network computers which render the information on the standard and network display screens respectively. The first input signal causes the cursor to change a current position state of display on either the first computer display screen or the second computer display screen (i.e., back and forth from either the first computer display screen to the second computer display screen or then back from the second computer display screen to the first computer display screen) and simultaneously causes the cursor to move in a plurality of directions and over a plurality of distances on either the first computer display screen or the second computer display screen. The programmable computer implemented switch module relays one or more signals simultaneously either causing display of movement and/or positioning of the cursor on the second computer display screen, when the switch position of the input switch changes to communicatively connect to the second device driver or simultaneously displaying the cursor on the first computer display screen when the switch position of the input switch changes to connect to the first device driver. The input switch transmits a third plurality of signals from the one or more input devices to control application programs executing on either the first computer or the second computer, when the switch position of the input switch changes to communicatively connect to either the first device driver or the second device driver respectively; thus the position of the input switch throw may be used to determine that the current position state of display of the cursor reaches predetermined boundaries in or between the first computer display screen and the second computer display screen of a plurality of machines. However, it is worth noting that boundaries between display screens may not exist explicitly in the controlling software. The one or more input devices can be communicatively coupled to either the first device driver or the second device driver through the third device driver, when the switch position of the programmable computer implemented switch module changes to communicatively connect to either the first device driver or the second device driver respectively. The first computer display screen and the second computer display screen and/or a plurality of additional computer display screens can be configured to form a multi-display, which comprises low resolution sub displays and/or network computer displays in combination with one or more full resolution displays, which can be standard display screens.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings, which are meant to be exemplary, and not limiting, wherein:

FIG. 1 illustrates a system for controlling multiple machines with a programmable switch network node.

FIG. 2 illustrates operations of a method of controlling multiple machines with a programmable switch network node.

FIG. 3 illustrates a system for controlling multiple machines using a programmable switch as part of one of the computer systems in a computer network.

FIG. 4 illustrates operations of a method of controlling multiple machines with a programmable switch as part of one of the computer systems in a computer network.

### DETAILED DESCRIPTION OF THE PREFERRED EMBODIMENTS

The disclosed exemplary embodiments are intended to be illustrative only, since numerous modifications and variations therein will be apparent to those of ordinary skill in the art. In reference to the drawings, like numbers will indicate like parts continuously throughout the view. Further, the terms “a”, “an”, “first”, “second” and “third” herein do not denote limitations of quantity, but rather denote the presence of one or more of the referenced item(s).

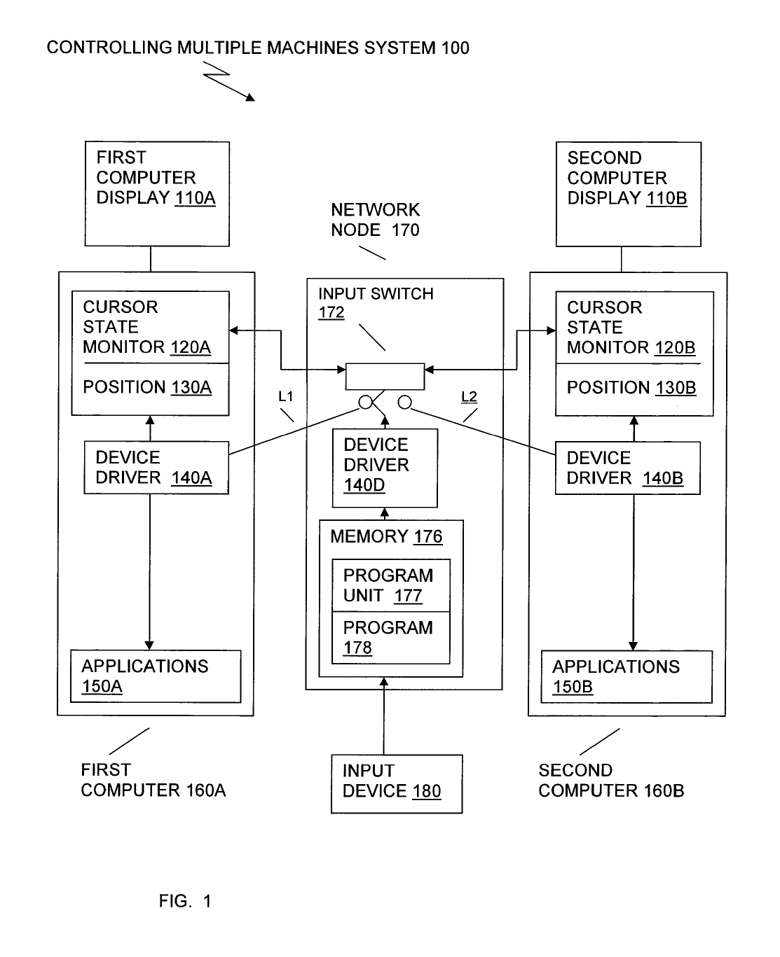

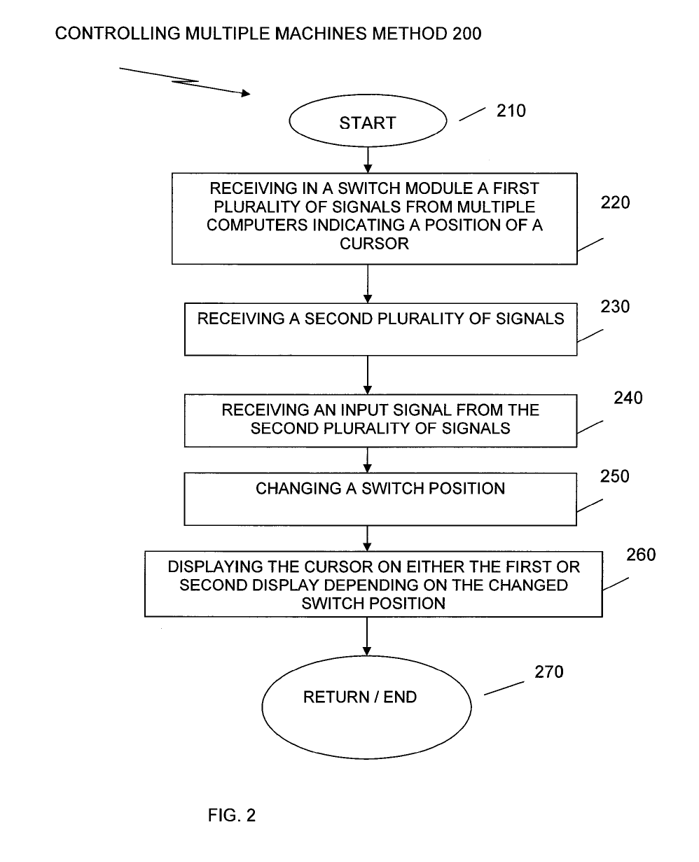

In exemplary embodiments, a controlling multiple machines system 100 (herein referred to as the “system 100”, illustrated in FIG. 1, as described by claim 1) includes a program 178 containing a controlling multiple machines method 200 (herein referred to as the “method 200”, illustrated in FIG. 2, as described in claim 2) stored in a memory 176 and when executed, the program 178 causes a network node 170 in association with a plurality of computers including a first and second computers 160A and 160B respectively, having a plurality of computer displays, to control the plurality of computers and causes a cursor to move seamlessly between the plurality of computer displays.

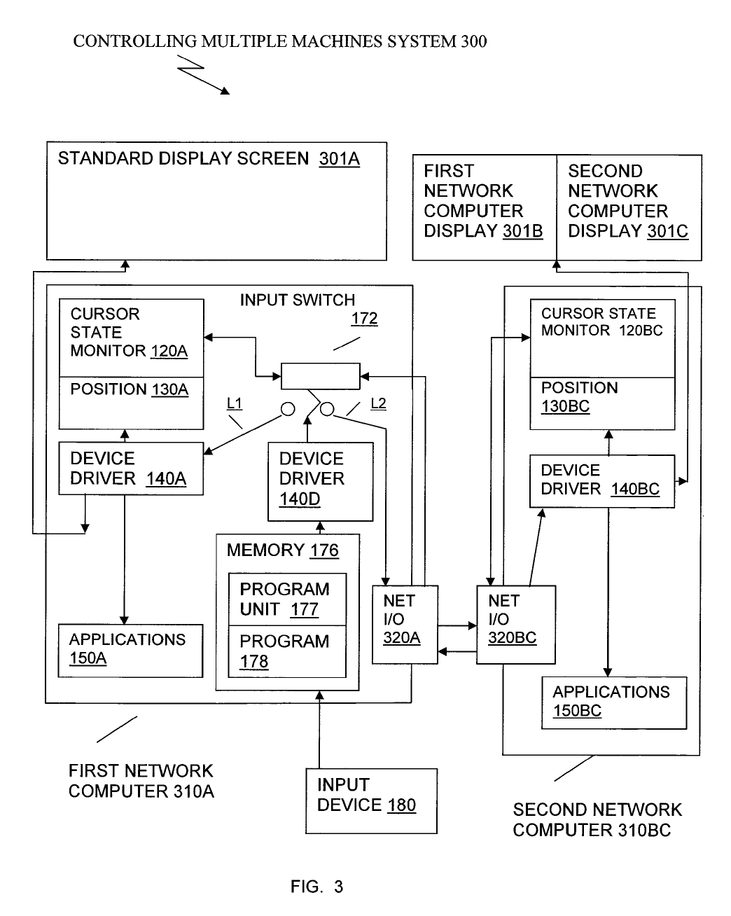

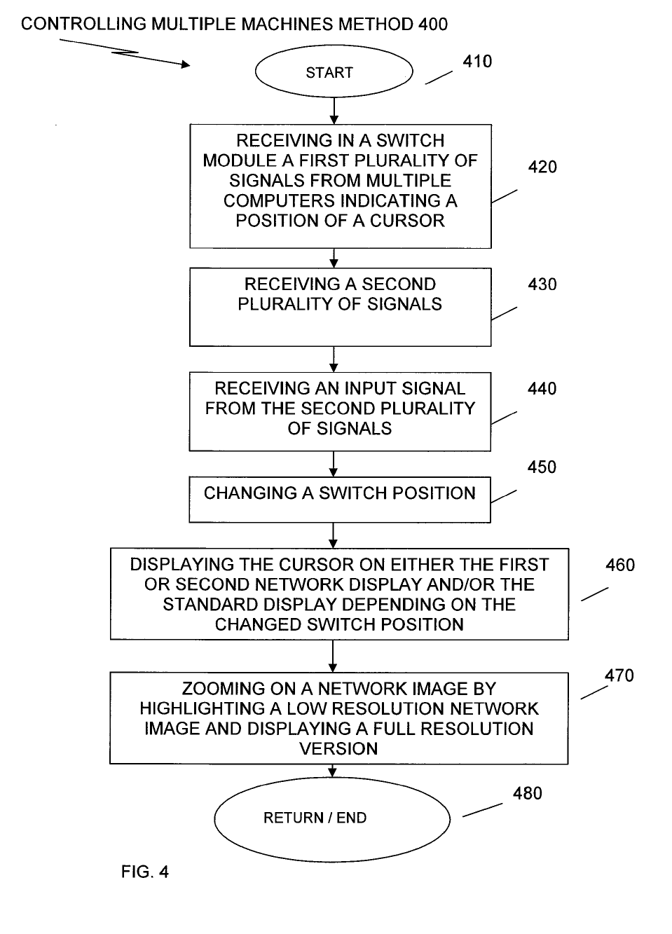

Further, in exemplary embodiments, a controlling multiple machines system 300 (herein referred to as the “system 300”, illustrated in FIG. 3) also includes the program 178 containing a controlling multiple machines method 400 (herein referred to as the “method 400”, illustrated in FIG. 4) also stored in the memory 176 and when executed, the program 178 causes the switch 172 in association with a plurality of computers including a first and second network computer 310A and 310BC respectively, having a plurality of computer displays, to control the plurality of computers and causes a cursor to move seamlessly between the plurality of computer displays, such as a standard display screen 301A and first and second network computer displays 301B and 301C.

In the exemplary embodiments, the controlling multiple machines' systems and methods such as the system 100, the method 200, the system 300 and the method 400 can be implemented in software (e.g., firmware), hardware or a combination of both. According to exemplary embodiments, the method 200 (as illustrated in FIG. 2) and the method 400 (as illustrated in FIG. 4) are implemented in software, as computer-executable program code, such as the program 178. The program 178 contains an ordered listing of computer-executable instructions for implementing logical functions, and which computer-executable instructions are executed by a special or general-purpose digital computer including a personal computer, a workstation, a minicomputer, a mainframe computer, an application specific integrated circuit (ASIC) containing a computer processor and/or a microprocessor (in the exemplary embodiments, the first and second computers 160A and 160B, the network node 170, as well as a first network computer 310A and a second network computer 310BC may contain such general purpose computers and/or processors), where the first network computer 310A and the second network computer 310BC may be at least two or more of a plurality of standard and/or network computers.

In the exemplary embodiments, such general purpose digital computers and/or processors may be a hardwired device or devices for executing software including software stored in the memory 176 (as illustrated in FIGS. 1 and 2. The software and/or computer-executable program code (such as the program 178) contained in the memory 176 includes a suitable operating system. In the exemplary embodiments a program unit 177 may include a computer program product containing the program 178 as illustrated in FIG. 1 and FIG. 3 on a computer usable medium including volatile and non-volatile memory elements, where the program unit 177 resides in memory 176.

In the exemplary embodiments, the memory 176 may include any one of and/or combination of volatile memory elements, including random access memory (i.e., including RAM, DRAM, SRAM and/or SDRAM) and non-volatile memory elements including read only memory (i.e., ROM, erasable programmable read only memory, electronically erasable programmable read only memory EEPROM, programmable read memory PROM, and/or compact disc read only memory CD-ROM or FLASH memory), memory stick, magnetic tape, disk, diskette, cartridge, cassette and/or optical memory. The memory 176 can have an architecture where various components are situated remotely from one another, but can be accessed by the general purpose digital computers, such as the first and second computers 160A and 160B (as illustrated in FIG. 1) and the first network computer 310A and the second network computer 310BC (as illustrated in FIG. 3). In the exemplary embodiments, the general purpose digital computers and/or processors can be any custom made or commercially available, off-the-shelf processor, a central processing unit (CPU), one or more auxiliary processors, a semiconductor based microprocessor, in the form of a microchip or a chip set, a macroprocessor and/or generally any device for executing software instructions, including ASICs.

In the exemplary embodiments, the system 100 and the system 300, when implemented in hardware, can each include discrete logic circuits having logic gates for implementing logic functions upon data signals.

In the exemplary embodiments, an at least one input device used by a user, (such as the input device 180) can be at least one of a mouse, a keyboard, a touch screen, a joystick, a thumbwheel, a light pen wand, or a microphone.

In the exemplary embodiments, the input switch (such as the input switch 172) may be a programmable computer implemented switch module, or a switch that has the ability to receive signals, but which is not programmable, and the input switch 172 need not be implemented with a computer in order for the invention to be realized or the input switch 172 may be incorporated in a network node (such as network node 170, illustrated in FIG. 1) or the input switch 172 may be a plug-in module, plugged into either a first or second computer system, or can be a software module residing in a program memory of either the first or second computer system. The input switch 172 receives, a first input signal of the second plurality of signals from the one or more input devices, where the first input signal is one or more of an x-signal and/or a y-signal, conveying either movement relating to a mouse or some other type of input device and corresponding to and/or causing cursor movement on a display screen, and where the x-signal and or the y-signal represent any general form of coordinate notation system. The first input signal from the second plurality of signals is relayed to either a first application or operating system or display driver responsible for rendering the display properties, such as the cursor and/or cursor position of the first computer display screen or a second application or operating system or display driver responsible for rendering the display properties, such as the cursor and/or cursor position of the second computer display screen, and where position data change automatically for a cursor associated with a first display, while the cursor moves in its rendering on the second display. These signals are relayed to the associated computers standard and network computer systems, over the network, where these computers render the information on the computer displays, including the standard and network computer display screens respectively. The first input signal causes the cursor to change a current position state of display on either the first computer display screen or the second computer display screen or the first network computer screen or the second network computer screen (i.e., back and forth from either the first computer display screen to the second computer display screen or then back from the second computer display screen to the first computer display screen) and simultaneously causes the cursor to move in a plurality of directions and covering a plurality of distances on either the first computer display screen or the second computer display screen. The switch position is automatically changed in the programmable computer implemented switch module (i.e., the input switch 172) so as to communicatively connect the switch module to either the first device driver (such as device driver 140A, connected by way of lead L1) or the second device driver (such as device driver 140B, connected by way of lead L2), when the program 178 determines that the current position state of display of movement and/or positioning of the cursor reaches a predetermined boundary in the first computer display screen and a predetermined boundary in the second computer display screen (including the first and second computers 160A and 160B and the first and second network computers 310A and 310BC). The predetermined boundary is a predicate of position states the cursor must satisfy in one of the first computer display screen and the second computer display screen in order for switching between the first computer display screen and the second computer display screen to be accomplished, where the switch position corresponds to (as determined by the program 178) coupling between the input device and the first and second device drivers and between the input device and the first and second network computer systems, and where the switching predicate is computed on either the first computer or the second computer or in the network node 170 or the switching predicate may be computed on the input switch 172 itself, and where the input switch 172 receives the switch signal when the switching predicate is satisfied. Thus, the input switch 172 must receive information to know whether the switching predicate has been satisfied. It does not matter where the predicate is computed. In the exemplary embodiments the switching predicate can be computed from position data supplied to the input switch 172 from the computer displaying the cursor. When the input switch 172 receives the switch signal, the switching predicate is satisfied; when the input switch 172 does not receive the switch signal, the switching predicate is not satisfied and the cursor is not rendered on the first network display computer system display screen and second network computer system display screen; thus, the input switch 172 may be in a null position (such as in a position not connected to either lead L1 or lead L2).

In the exemplary embodiments, the first computer display 110A and the second computer display 110B (as illustrated in FIG. 1) and the standard display screen 301A and the first network computer display 301B and the second network computer display 301C (as illustrated in FIG. 3) compose at least two or more of a plurality of standard and/or network display screens.

In the exemplary embodiments (referring to FIGS. 1 and 3), the input switch 172) relays cursor state data bi-directionally between the first computer and the second computer (such as the first computer 160A and the second computer 160B, illustrated in FIG. 1 or the first network computer 310A or the second network computer 310BC, illustrated in FIG. 3), by way of device driver 140A and/or device driver 140B, depending on whether the input switch is connected to either lead L1 or lead L2 respectively, thereby generating a seamless transition of the cursor rendering. Thus, position data may change for a given cursor associated with a given display, while the cursor actually moves in its rendering on the other display; thereby describing two different cursor rendering events respective to a given display. The first computer (such as the first computer 160A or the first network computer 310A) includes a first device driver (such as a device driver 140A) and the second computer (such as the second computer 160B and the second network computer 310BC) includes a second device driver (such as a device driver 140B and a device driver 140BC respectively), where one of a plurality of display screens can be a standard display screen, which is a full resolution display, associated with a computer system (such as the first and second computer systems 160A and 160B, as well as the first and second network computers 310A and 310BC), required for scaling large numbers of a plurality of network computer system display screens, and where another display screen can be the network computer system display screen of the multi-display computer system where the other display screen may be a low resolution network computer display screen embedded in the second network computer display screen, operating at resolutions lower than the full resolution display, which may include low resolution network computer display screen operation, operating at resolutions lower than the full resolution display.

In the exemplary embodiments, a device driver (such as device drivers 140A, 140B, 140BC and 140D) may be defined as a device and/or module used to accomplish a described functionality of the method of controlling multiple machines using a seamless user interface to a multi-display system (such as a system 100 and/or a system 300), where multiple machines may include parallel architecture systems having multi-displays configured from a plurality of contiguous sub displays (i.e., where the plurality of contiguous sub displays can be network computer displays, (such as a first network computer display 301B and/or a second network computer display 301C) in a parallel hardware system involving multi-machine management/use systems, multiple human interface front of screen display configurations and user input devices (such as the input device 180). Therefore, the use of the term device driver is expanded beyond the traditional meaning of that of an extension to an operating system. Furthermore, where a device drive (such as the device driver 140A, 140B, 140BC and/or device driver 140D) is described as controlling a stand alone input switch (such as the input switch 172), it necessarily suggests that the input switch 172 possesses an operating system; however, the input switch 172 may or may not posses an operating system. Thus, in the exemplary embodiments, where the input switch 172 may have no device driver, the input switch 172 merely serves as a relay, relaying signals from input devices (such as input device 180) to device drivers (such as device drivers 140A, 140B, 140BC and device driver 140D).

In the exemplary embodiments, a user of any of the multi-display computer systems using the input device 180, moves the cursor through the plurality of network computer system display screens (such as the first computer display 110A, the second computer display 110B, the standard display screen 301A, the first network computer display 301B and the second network computer display 301C) any of which may operate at resolutions lower than the full resolution display or may operate as the full resolution display and the user using the input device 180 may select an at least one of the plurality of computer display screens, where selecting the at least one of the plurality of computer display screens causes an output of the at least one of the plurality of computer display screens to be input to and displayed on the full resolution display, where selecting includes one or more of simply clicking and right clicking and highlighting and zooming on an image in the at least one of the plurality of network computer display screens, and where the output is a real-time image.

In the exemplary embodiments, the functionality of the first computer 160A and/or the second computer 160B and/or the first network computer 310A and/or the functionality of the second network computer 310BC may be rendered in a single network computer system. In the exemplary embodiments, the multi-displays are not derived from the network continuously (i.e., the components are not representations of network computer displays), but instead may be simply icons, text, and/or static data conveyed over the network during setup, or during periodic samples of the displays.

In the exemplary embodiments, input switch (which may include a programmable computer implemented switch module) may receive, from a third device driver (such as the device driver 140D) a second plurality of signals via one or more input devices. The third device driver is communicatively coupled to the input switch 172, as described by the programmable computer implemented switch module; and the one or more input devices (such as the input device 180) may be communicatively coupled to the third device driver 140D. The term(s) communicatively coupled and/or communicatively connected may be defined as, but not limited to local, i.e., internal, as well as external physical interface connectivity allowing communications between modules; for example, one or more buses or other wired or wireless connections, as is known in the art. The interface(s) may have additional elements, which are omitted for simplicity, such as controllers, buffers (caches), drivers, repeaters, and receivers, contacts and leads to enable communications. Further, the interface(s) (such as user interfaces) may include address, control, and/or data connections to enable appropriate communications among the aforementioned components.

Referring to FIG. 1 and FIG. 2, according to the first exemplary embodiment, the system 100 is communicatively coupled to the network node 170 having an input switch 172, which may be a programmable input switch. The network node 170 also includes a device driver 140D and a memory 176. Residing in the memory 176 is a program unit 177 containing a program 178. The program 178 contains computer-executable program code that when executed by the general purpose computer such as the first and second computers 160A and 160B (where the first and second computers 160A and 160B include a first computer display 110A and a second computer display 110B respectively of a plurality of computer displays), causes the first and second computers 160A and 160B to perform the method 200 of controlling multiple machines, so as to cause a cursor to move seamlessly back and forth between the plurality of computer displays, such as the first computer display 110A and the second computer display 110B.

In the first exemplary embodiment, referring again to FIG. 1 and FIG. 2, at an operation start 210 (hereafter referred to as the “operation start 210”), the system 100 receives a signal from an operator and/or individual user input device such as the input device 180, which activates and initiates the program 178, where the method 200 is stored as computer executable program code on a computer executable medium.

Upon activation, the program 178 performs other operations of the method 200 from selection signals received from the input device 180, causing the program 178 to be executed by a plurality of computers, such as the first computer 160A and the second computer 160B to perform the operations of the method 200 of controlling multiple machines by causing a cursor to move seamlessly between a plurality of computer display screens such as the first computer display 110A and/or the second computer display 110B of the plurality of computer display screens.

Again, referring to FIG. 1 and FIG. 2, at an operation receiving in a switch module a first plurality of signals from multiple computers indicating a position of a cursor 220 (hereafter referred to as the “operation 220”), the program 178, containing the method 200, executed in a network node module, such as the network node 170, on the system 100, causes the method 200 to instruct the input switch 172 to instruct the input switch 172 to receive a first plurality of signals from multiple computers (such as the first computer 160A and the second computer 160B) indicating a position of a cursor displayed on either a first or second display (such as the first computer display 110A and/or the second computer display 110B). The input switch 172 may be a programmable computer implemented switch module, or a switch that has the ability to receive signals, but which is not programmable, and the input switch 172 need not be implemented with a computer in order for the invention to be realized or the input switch 172 may be a plug-in module plugged into either the first network computer system and the second network computer system (such as the first computer 160A and/or the second computer 160B, or the input switch 172 may be a software module residing in a program memory (such as the memory 176) of either the network node 170 and/or either the first network computer system and/or the second network computer system (such as the first computer 160A and/or the second computer system 160B.

In the first exemplary embodiment, illustrated in FIG. 1, a cursor state monitor (such as a cursor state monitor 120A and/or a cursor state monitor 120B) provides an indication, (for an at least one signal of the first plurality of signals) of the current position state of display and movement and/or positioning of a cursor being rendered and displayed on either the first computer display 110A and/or the second computer display 110B. The first computer display screen 110A and the second computer display screen 110B are communicatively coupled to the first computer 160A and the second computer 160B respectively.

Again referring to the first exemplary embodiment (illustrated in FIGS. 1 and 2), at an operation receiving a second plurality of signals 230 (hereafter referred to as the “operation 230”), the program 178, containing the method 200, executed on the system 100, causes the method 200 to instruct the input switch 172 to receive, from a third device driver (such as a device driver 140D) a second plurality of signals via one or more input devices (such as the input device 180). The third device driver 140D is communicatively coupled to the input switch 172. The one or more input devices (such as the input device 180) is communicatively coupled to the third device driver 140D.

In the first exemplary embodiment, at an operation receiving an input signal from the second plurality of signals 240 (hereafter referred to as the “operation 240”), the program 178, containing the method 200, executed on the system 100, causes the method 200 to instruct the input switch 172 to receive a first input signal of the second plurality of signals from the one or more input devices (such as the input device 180). The first input signal is either one or more of an x-signal and/or a y-signal, conveying either movement of a mouse or some other type of input device (such as input device 180) and/or cursor movement on a display screen (such as the first and second computer displays 110A and 110B) The x-signal and the y-signal representations are not limiting; thus, other coordinate notations systems may be used to represent operational coordinates in the exemplary embodiment. The first input signal from the second plurality of signals is relayed to either a first application or operating system or display driver responsible for rendering the display properties, such as the cursor and/or cursor position of the first computer display screen or a second application or operating system or display driver responsible for rendering the display properties, such as the cursor and/or cursor position of the second computer display screen, where the first and second applications can be applications such as an application 150A and an application 150B, and where the program 178, containing the method 200, executed on the system 100, causes the method 200 to cause the position data to change automatically for a cursor associated with a first display (such as the first computer display 110A), while the cursor moves in its rendering on the second display, (such as the second computer display 110B). These signals are relayed over the network to the standard and/or network computer systems (such as the first computer 160A and/or the second computer 160B, which render the information on the standard and/or network display screens (such as the first computer display 110A and the second computer display 110B respectively. As determined by the program 178, the first input signal causes the cursor to change a current position state of display on the display screens of either the first computer display 110A and/or the second computer display 110B (i.e., back and forth from either the first computer display 110A to the second computer display 110B or then back from the second computer display 110B to the first computer display 110A) and simultaneously causes the cursor to move in a plurality of directions and traversing a plurality of distances on either the first computer display 110A or the second computer display 110B.

In the first exemplary embodiment, at an operation changing a switch position 250 (hereafter referred to as the “operation 250”), the program 178 causes the method 200 to instruct the input switch 172 (resulting from the first input signal) to cause the cursor to change a current position state of display on the display screens of either the first computer display 110A or the second computer display 110B (i.e., back and forth from either the first computer display 110A to the second computer display 110B or then back from the second computer display 110B to the first computer display 110A) and simultaneously causes the cursor to move in a plurality of directions and a plurality of distances on either the first computer display 110A or the second computer display 110B, depending on the actual switch position of the switch throw of input switch 172 (in FIG. 1 of the first exemplary embodiment, the switch throw of the input switch 172 is illustrated as being connected to lead L1; however, this depicted connectivity is merely presented as an illustration and the switch throw of input switch 172 may be illustrated as connected to lead L2 or not connected to either lead L1 or lead L2, in which case the input switch 172 may correspondingly be in the null position). As determined by the program 178, the first input signal causes the cursor to change a current position state of display on the display screens of either the first computer display 110A and/or the second computer display 110B (i.e., back and forth from either the first computer display 110A to the second computer display 110B or then back from the second computer display 110B to the first computer display 110A) and simultaneously causes the cursor to move in a plurality of directions and traversing a plurality of distances on either the first computer display 110A or the second computer display 110B. The switch position is automatically changed in the programmable computer implemented switch module (i.e., the input switch 172), in accordance with the program 178, so as to communicatively connect the switch module (such as the input switch 172) to either the first device driver (such as the device driver 140A) or the second device driver (such as the device driver 140B), when the programmable computer implemented switch module (such as the input switch 172), in accordance with the program 178 determines that the current position state of display of movement and/or positioning of the cursor reaches a predetermined boundary in the screens of the first computer display 110A and the second computer display 140B. Thus, the switch position is automatically changed in the programmable computer implemented switch module (i.e., the input switch 172) so as to communicatively connect the switch module (such as the input switch 172) to either the first device driver (such as the device driver 140A) or the second device driver (such as the device driver 140B), when the programmable computer implemented switch module (such as the input switch 172) determines that the current position state of display of movement and/or positioning of the cursor reaches a predetermined boundary in the screens of the first computer display 110A and the second computer display 140B, where the predetermined boundary is a predicate of position states the cursor must satisfy in one of the first computer display screen and the second computer display screen in order for switching between the first computer display screen and the second computer display screen to be accomplished, where the switch position determines coupling between the input device and the first and second device drivers and between the input device and the first and second network computer systems, and where the switching predicate is computed on either the first computer or the second computer, or the input switch itself, and where the input switch receives the switch signal when the switching predicate is satisfied. When the input switch 172 receives the switch signal, the switching predicate is satisfied; when the input switch 172 does not receive the switch signal, the switching predicate is not satisfied and the cursor is not rendered on the first network display computer system display screen and second network computer system display screen; thus, the input switch 172 may be in a null position. Thus, the input switch 172 must receive information to know whether the switching predicate has been satisfied. In the exemplary embodiments the switching predicate can be computed from position data supplied to the input switch from the computer displaying the cursor.

In the first exemplary embodiment, at operation displaying the cursor on either the first or second display depending on the changed switch position 260 (hereafter referred to as the “operation 260”), the program 178 causes the method 200 to instruct the input switch 172 to relay one or more signals simultaneously either causing display of movement and/or positioning of the cursor on the second computer display screen (such as the second computer display 110B), when the switch position of the input switch 172 changes to communicatively connect to the second device driver or simultaneously displaying the cursor on the first computer display screen (such as the first computer display 110B), when the switch position of the input switch 172 changes to connect to the first device driver, such as the device driver 140A. The input switch 172 transmits a third plurality of signals from the one or more input devices (such as the input device 180) to control application programs (such as the applications 150A and 150B) executing on either the first computer 160A or the second computer 160B respectively, when the switch position of the input switch 172 changes to communicatively connect to either the first device driver (such as device driver 140A) or the second device driver (such as the device driver 140B) respectively, corresponding to the transmitted signals in this transmitting operation. The one or more input devices (such as the input device 180) can be communicatively coupled to either the first device driver or the second device driver through the third device driver, when the switch position of the programmable computer implemented switch module changes to communicatively connect to either the first device driver (such as device driver 140A) or the second device driver (such as device driver 140B) respectively. The first computer display 110A and the second computer display 110B and/or a plurality of additional computer display screens can be configured to form a multi-display; thus, the position of the throw of the input switch 172 may be used to determine that the current position state of display of the cursor reaches a predetermined boundary in the first computer display 110A and the second computer display 110B.

In the first exemplary embodiment, at an operation return/end 270, the program 178 causes the method 200 to either return to any one or more of operations 220 through 260 to continue processing or to end the processing of said operations of the method 200.

In a second exemplary embodiment, referring to FIGS. 3 and 4, the input switch 172 may be incorporated into any one or more of the network display computers (such as the first network display computer 310A or the second network computer 310BC). The input switch 172 may be a programmable computer implemented switch module, or a switch that has the ability to receive signals, but which is not programmable, and the input switch 172 need not be implemented with a computer in order for the invention to be realized or the input switch 172 may be a plug-in module plugged into either the first network computer 310A and/or the second network computer 310BC, or the input switch 172. In addition, the input switch 172 may be a software module residing in a program memory (such as the memory 176) of either the network node 170 and/or one of the first network computer 310A and/or the second network computer 310BC.

In the second exemplary embodiment, again referring to FIG. 3 and FIG. 4, at an operation start 410 (hereafter referred to as the “operation start 410”), the system 300 receives a signal from an operator and/or individual user input device such as the input device 180, which activates and causes initiation of the program 178, where the method 400 is stored as computer executable program code on a computer executable medium.

Upon activation, the program 178 performs other operations of the method 400 from selection signals received from the input device 180, causing the program 178 to be executed by a plurality of computers, such as the first network computer 310A, and the second network computer 310BC, to perform the operations of the method 400 of controlling multiple machines by causing a cursor to move seamlessly between a plurality of computer display screens such as the standard display screen 301A and/or the first network computer display 301B and/or the second network computer display 301C of the plurality of computer display screens.

In the second exemplary embodiment, referring again to FIG. 3 and FIG. 4, at an operation receiving in a switch module a first plurality of signals from multiple computers indicating a position of a cursor 420 (hereafter referred to as the “operation 420”), the program 178, executed in at least one of a plurality of network computers, where examples of such network computers include the first network computer 310A and the second network computer 310BC. Any one or more of the first and second network computers 310A and/or 310BC may include a programmable computer implemented switch module, such as an input switch 172. The program 178, when executed, causes the method 400 to instruct the input switch 172 to receive a first plurality of signals from multiple network display computers of the plurality of network display computers (such as the first network computer 310A and the second network computer 310BC) indicating a position of a cursor displayed on either a first or second or third display (such as a standard display screen 301A and/or a first network computer display 301B and/or a second network computer display 301C). The input switch 172 may be a programmable computer implemented switch module, or a switch that has the ability to receive signals, but which is not programmable, and the input switch 172 need not be implemented with a computer in order for the invention to be realized or the input switch 172 may be a plug-in module plugged into either the first network display computer 310A and/or the second network computer 310BC, or the input switch 172 can be implemented as a software module residing in a program memory (such as the memory 176) of one or more of the first network computer 310A and/or the second network computer 310BC.

In the second exemplary embodiment, a cursor state monitor (such as a cursor state monitor 120A and/or a cursor state monitor 120BC) provides an indication, (for an at least one signal of the first plurality of signals) of the current position state of display and movement and/or positioning of a cursor being rendered and displayed on either the standard display screen 301A, the first network computer display 301B and/or the second network computer display 301C. The standard display screen 301A is communicatively coupled to the first network computer 310A. The first network computer display 301B and the second network computer display 301C are communicatively coupled to the second network computer 310BCB.

Again referring to the second exemplary embodiment (illustrated in FIGS. 3 and 4), at an operation receiving a second plurality of signals 430 (hereafter referred to as the “operation 430”), the program 178 causes the method 400 to instruct the input switch 372 to receive, from a third device driver (such as a device driver 140D) a second plurality of signals via one or more input devices (such as the input device 180). The third device driver 140D is communicatively coupled to the input switch 172, which may be a programmable computer implemented switch module. The one or more input devices (such as the input device 180) can be communicatively coupled to the third device driver 140D.

In the second exemplary embodiment, at an operation receiving an input signal from the second plurality of signals 440 (hereafter referred to as the “operation 440”), the program 178 causes the method 400 to instruct the input switch 172 to receive a first input signal of the second plurality of signals from the one or more input devices (such as the input device 180). The first input signal is either one or more of an x-signal and/or a y-signal, conveying either movement of a mouse or some other type of input device and/or cursor movement on a display screen. However, the movements of a mouse or other input device, may be represented by other coordinate notation systems. The first input signal from the second plurality of signals is relayed to either a first application or operating system or display driver responsible for rendering the display properties, such as the cursor and/or cursor position of the first computer display screen or a second application or operating system or display driver responsible for rendering the display properties, such as the cursor and/or cursor position of the second computer display screen, and where position data change automatically for a cursor associated with a first display (such as the standard display screen 301A), while the cursor moves in its rendering on the second or third display, (such as the first network computer display 301B and/or the second network computer display 301C respectively).

In the second exemplary embodiment, referring to FIGS. 3 and 4, the x and y signals are relayed over the network via network components (such as network input/output components, i.e., NET I/O 320A and/or NET I/O 320BC) to the standard display screen 301A and/or the first network computer display 301B and/or the second network computer display 301C, where any of the standard display screen 301A and/or the first network computer display 301B and/or the second network computer display 301C can render the cursor information. The first input signal causes the cursor to change a current position state of display on the display screens of either the standard display screen 301A and/or the first network computer display 301B and/or the second network computer display 301C (i.e., back and forth through NET I/O 320A and/or NET I/O 320BC from either the standard display screen 301A to the first network computer display 301B and/or the second network computer display 301C, or then back through NET I/O 320A and/or NET I/O 320BC from the first network computer display 301B and/or the second network computer display 301C to the standard display screen 301A) and simultaneously the first input signal can cause the cursor to move in a plurality of directions and a plurality of distances on either the standard display screen 301A and/or the first network computer display 301B and/or the second network computer display 301C. The switch position is automatically changed in the input switch 172, so as to communicatively connect the input switch 172 to either the first device driver 140A or the second device driver 140BC, when the input switch 172 (where the input switch 172 may be a programmable computer implemented switch module) determines that the current position state of display of movement and/or positioning of the cursor reaches a predetermined boundary in the screens of the standard display screen 301A and/or the first network computer display 301B and/or the second network computer display 301C.

In the second exemplary embodiment, referring to FIG. 3, the NET I/O 320A and/or NET I/O 320BC may be stand along programmable computer implemented network input/output modules connected to the computers via known cabling methods, or may be plug-in modules plugged into either the first network computer 310A and/or the second network computer 310BC; furthermore, the NET I/O 320A and/or NET I/O 320BC can be implemented as software interface driver modules residing in a program memory (such as the memory 176) of one or more of the first network computer 310A and/or the second network computer 310BC.

In the second exemplary embodiment, at an operation changing a switch position 450 (hereafter referred to as the “operation 450”), the program 178 causes the method 400 to instruct the input switch 172 (resulting from the first input signal) to cause the cursor to change a current position state of display on the display screens of either the standard display screen 301A and/or the first network computer display 301B and/or the second network computer display 301C (i.e., back and forth from either the standard display screen 301A to the first network computer 310A and/or the second network computer 310BC and simultaneously causes the cursor to move in a plurality of directions and cover/traverse a plurality of distances on either the standard display screen 301A and/or the first network computer 310A and/or the second network computer 310BC, depending on the actual switch position of the switch throw of input switch 172 (in FIG. 2 of the first exemplary embodiment, the switch throw of the input switch 172 is illustrated as being connected to lead L2; however, this depicted connectivity is merely presented as an illustration and the switch throw of input switch 172 may be illustrated as connected to lead L1 or not connected to either lead L1 or lead L2, in which case the input switch 172 may be in the null position). The switch position can be automatically changed in the input switch 172 (which may be a programmable computer implemented switch module) so as to communicatively connect the input switch 172 to either the first device driver 140A or the second device driver 140BC, when the input switch 172 (which may be a programmable computer implemented switch module) determines that the current position state of display of movement and/or positioning of the cursor reaches a predetermined boundary in the screens of the standard display screen 301A and/or the first network computer display 301A and/or the second network computer display 301BC, wherein the predetermined boundary is a switching predicate of position states the cursor must satisfy in one of the first network computer system and the second network computer system associated with the standard display screen 301A and the first and second network computer displays 301B and 301C in order for switching between one and/or another computer display screen to be accomplished and in turn in order for the relative movement of a cursor to be rendered on the computer screens (such as the standard display screen 301A and the first and second network computer displays 301B and 301C), where the switch position indicates coupling between the input device 180 and the first and second device drivers 140A and 140BC and between the input device 180 and the first and second network computers 310A and 310BC, and where the switching predicate is computed on either the first network computer 310A or the second network computer 310BC, or the input switch 172 and where the input switch 172 receives the switch signal when the switching predicate is satisfied. Furthermore, when the input switch 172 does not receive the switch signal, the switching predicate is not satisfied and the cursor is not rendered on either of the standard display screen 301A or the first network computer display 301B or the second network computer display 301C; thus, the input switch may be in a null position.

In the second exemplary embodiment, at operation displaying the cursor on either the first or second network display and/or the standard display depending on the changed switch position 460 (hereafter referred to as the “operation 460”), the program 178 causes the method 400 to instruct the input switch 172 to relay one or more signals simultaneously either causing display of movement and/or positioning of the cursor on the second network computer display 301C, or the first network computer display 301B, when the switch position of the input switch 172 changes to communicatively connect to the second device driver 140BC or simultaneously displaying the cursor on the standard display screen 301A when the switch position of the input switch 172 changes to connect to the first device driver 140A. The input switch 172 transmits a third plurality of signals from the one or more input devices (such as input device 180) to control application programs (such as applications 150A and/or Applications 150BC) executing on either the first computer or the second computer respectively, when the switch position of the input switch 172 changes to communicatively connect to either the first device driver 140A or the second device driver 140BC respectively. The one or more input devices (such as the input device 180) can be communicatively coupled to either the first device driver 140A or the second device driver 140BC through the third device driver 140D, when the switch position of the input switch 172 changes to communicatively connect to either the first device driver 140A or the second device driver 140BC respectively.

In the second exemplary embodiment, referring to FIGS. 3 and 4, the standard display screen 301A, the first network computer display 301B and/or the second network computer display 301C and/or a plurality of additional computer display screens can be configured to form a multi-display, which comprises low resolution sub displays (such as the first network computer display 301B and/or the second network computer displays 301C in combination with one or more full resolution displays, which can be a standard display screen(s), such as standard display screen 301A, where a user of the multi-display computer system using an input device, such as the input device 180, moves the cursor through the plurality of network display computer system display screens (such as the first network computer display 301B and the second network computer display 301C, operating at resolutions lower than the full resolution display, and where the full resolution display may be the standard display screen 301A) and selects an at least one of the plurality of network display computer display screens (such as the first network computer display 301B and the second network computer display 301C).

In the second exemplary embodiment, at an operation zooming on a network image by highlighting a low resolution network image and displaying a full resolution version 470 (hereafter referred to as “the operation 470”), the program 178 receives the selecting signal from the input device 180 and where the selecting the at least one of the plurality of network display computer display screens causes the program 178 to provide an output via one of the device drivers (such as the device driver 140A or the device driver 140D or the device driver 140BC) of the at least one network image displayed on at least one of the plurality of network display computer display screens to be input to and displayed as a full resolution network image version of the low resolution network image on the full resolution display (such as the standard display screen 301A), where selecting may include one or more of simply clicking and/or right clicking and/or highlighting and/or zooming on an image in the at least one of the plurality of network display computer screens and/or sub displays and/or multi-displays (such as the first network computer display 301B and the second network computer display 301C), and where the output is a real-time image.

In the second exemplary embodiment, at an operation return/end 480, the program 178 causes the method 400 to either return to any one or more of operations 420 through 460 to continue processing or to end the processing of said operations of the method 400.

In the exemplar embodiments, the program 178 can operate to cause the methods 200 and 400 respectively to return to any one or more of operations 220 through 260 and operations 420 through 470 to continue iteratively processing and performing any one or more of said operations until the it is determined that the operations are completed where the program 178 can direct the methods 200 and/or 400 to end.

The exemplary embodiments can be carried out in the form of computer-implemented processes, apparatuses and computer-readable media (or a computer-readable medium) for practicing those processes. In the exemplary embodiments, the invention is practiced using computer program code executed by one or more network elements.

While the disclosure has been described with reference to exemplary embodiments, it will be understood by those skilled in the art that various changes may be made and equivalents may be substituted for elements thereof, without departing from the scope of the disclosure. In addition, many modifications may be made to adapt a particular situation or material to the teachings of the disclosure without departing from the essential scope thereof For example, all of the claimed embodiments may apply to configurations of more than one computer system. Therefore, it is intended that the disclosure not be limited to the particular exemplary embodiment and/or embodiments disclosed as the best mode contemplated for carrying out this disclosure, but that the disclosure will include all embodiments falling within the scope of the appended claims.

What is claimed is:

1. A method of controlling a first computer and a second computer using a seamless user interface; the method comprising:
receiving, in an input switch, a first plurality of signals from the first computer and the second computer, wherein an at least one signal of the first plurality of signals indicates a current position state of display of a cursor being rendered on one of a display screen of the first computer and a display screen of the second computer, wherein the display screen of the first computer and the display screen of the second computer are communicatively coupled to the first computer and the second computer respectively, and wherein the first computer includes a first device driver and the second computer includes a second device driver;
receiving, from a third device driver a second plurality of signals from an at least one input device, wherein the third device driver is communicatively coupled to the input switch, and wherein the at least one input device is communicatively coupled to the third device driver;
receiving a first input signal of the second plurality of signals from the at least one input device, wherein position data change for the cursor associated with the display screen of the first computer, while the cursor moves in its rendering on the second display screen of the second computer; wherein the first input signal is one or more of an x-signal and a y-signal, conveying one of movement of a mouse and movement of the cursor, wherein the first input signal from the second plurality of signals is relayed to one of a first application display driver of the first computer and a second application display driver of the second computer, and wherein the first input signal causes the cursor to change the current position state of display on one of the display screen of the first computer and the display screen of the second computer and causes the cursor to move in a plurality of directions and a plurality of distances on one of the display screen of the first computer and the display screen of the second computer, and;
changing, automatically, a switch position of the input switch to communicatively connect to one of the first device driver and the second device driver, when the switch position of the input switch is used to determine that the current position state of display of the cursor reaches a predetermined boundary in the display screen of the first computer and the display screen of the second computer, wherein the predetermined boundary is a switching predicate of position states the cursor must satisfy in one of the display screen of the first computer and the display screen of the second computer in order for switching between the display screen of the first computer and the display screen of the second computer to be accomplished, wherein the switching predicate is computed on one of the first computer and the second computer, and the input switch, and wherein the input switch receives a switch signal when the switching predicate is satisfied;
performing one of simultaneously displaying and moving the cursor on the display screen of the second computer when the switch position of the input switch changes to connect to the second device driver and simultaneously displaying and moving the cursor on the display screen of the first computer, when the switch position of the input switch changes to connect to the first device driver, thereby creating a seamless transition of cursor rendering between the display screen of the first computer and the display screen of the second computer; and
transmitting a third plurality of signals from the at least one input device when the switch position of the input switch changes to connect to one of the first device driver and the second device driver respectively, wherein the at least one input device is communicatively coupled to one of the first device driver and the second device driver through the third device driver, when the switch position of the input switch changes to connect to one of the first device driver and the second device driver respectively.

2. The method of controlling the first computer and the second computer, according to claim 1, wherein the input switch is included in one of the first computer and the second computer.

3. The method of controlling the first computer and the second computer, according to claim 2, wherein the input switch is one of hardwired into one of the first computer and the second computer, and is a plug-in module plugged into one of the first computer and the second computer, and is a software module residing in a program memory of one of the first computer and the second computer.

4. The method of controlling the first computer and the second computer, according to claim 3, wherein the first computer and the second computer include a first network interface and a second network interface respectively, and wherein the first computer and the second computer are communicatively coupled over a computer network connected to the first network interface and the second network interface.

5. The method of controlling the first computer and the second computer, according to claim 4, further comprising receiving, in the input switch, the first plurality of signals from the second computer, transmitted over the computer network, wherein the at least one signal of the first plurality of signals indicates one of the current position state of display of the cursor being displayed on the second computer display screen when the switch position of the input switch changes to connect to the second device driver and the current position state of display of the cursor being displayed on the display screen of the first computer, when the switch position of the input switch changes to connect to the first device driver, wherein the at least one input device is communicatively coupled to the second device driver through the third device driver, when the switch position of the input switch changes to connect to the second device driver.

6. The method of controlling the first computer and the second computer, according to claim 5, further comprising transmitting over the computer network the third plurality of signals from the at least one input device to control application programs executing on the second computer, when the switch position of the input switch changes to connect to the second device driver.

7. A computer implemented system of controlling a first computer and a second computer using a seamless user interface; the computer implemented system comprising:
the first computer and the second computer communicatively coupled to a display screen of the first computer and a display screen of the second computer, respectively, wherein the first computer and the second computer contain a first device driver and a second device driver respectively;
an input switch module, which includes a computer processor and an input switch, is communicatively coupled over a computer network to the first computer and the second computer, wherein the input switch module includes a third device driver, which is communicatively coupled to an at least one input device;
a memory, including a program unit, resides in the input switch module, and wherein the program unit contains a program that when executed by the computer processor included in the input switch module, causes the input switch module to perform operations of:
receiving, in the input switch module, a first plurality of signals transmitted from the first computer and the second computer, wherein an at least one signal of the first plurality of signals indicates a current position state of display of a cursor being rendered on one of the display screen of the first computer and the display screen of the second computer;
receiving, from the third device driver a second plurality of signals from the at least one input device;
receiving a first input signal of the second plurality of signals from the at least one input device, wherein position data change for the cursor associated with the display screen of the first computer, while the cursor moves in its rendering on the display screen of the second computer, wherein the first input signal is one or more of an x-signal and a y-signal, conveying one of movement of a mouse and movement of the cursor, wherein the first input signal of the second plurality of signals is relayed to one of a first application display driver of the display screen of the first computer and a second application display driver of the display screen of the second computer, and wherein the first input signal causes the cursor to change the current position state of display on one of the display screen of the first computer and the display screen of the second computer and causes the cursor to move in a plurality of directions and traverse a plurality of distances on one of the display screen of the first computer and the display screen of the second computer;
changing, automatically, a switch position of the input switch to communicatively connect to one of the first device driver and the second device driver, when the position of a throw of the input switch is used to determine that the current position state of display of the cursor reaches a predetermined boundary in the display screen of the first computer and the display of the second computer, wherein the predetermined boundary is a switching predicate of position states the cursor must satisfy in one of the display screen of the first computer and the display screen of the second computer in order for switching between the display screen of the first computer and the display of the second computer to be accomplished, wherein the switching predicate is computed on one of the first computer and the second computer, and the input switch, and wherein the input switch receives a switch signal when the switching predicate is satisfied;
performing one of simultaneously displaying and moving the cursor on the display screen of the second computer, when the switch position of the throw of the input switch changes to connect to the second device driver and simultaneously displaying and moving the cursor on the display screen of the first computer, when the switch position of the throw of the input switch changes to connect to the first device driver, thereby creating a seamless transition of the cursor rendering between the display screen of the first computer and the display screen of the second computer; and
transmitting a third plurality of signals from the at least one input device when the switch position of the throw of the input switch changes to connect to one of the first device driver and the second device driver respectively, wherein the at least one input device is communicatively coupled to one of the first device driver and the second device driver through the third device driver, when the switch position of the throw of the input switch changes to connect to one of the first device driver and the second device driver respectively.

8. The system according to claim 7, wherein the input switch module is included in one of the first computer and the second computer.

9. The system according to claim 8, wherein the input switch module is one of hardwired into one of the first computer and the second computer, and is a plug-in module plugged into one of the first computer and the second computer, and is a software module residing in a program memory of one of the first computer and the second computer.

10. The system according to claim 9, wherein the first computer and the second computer include a first network interface and a second network interface respectively, and wherein the first computer and the second computer are communicatively coupled over the computer network connected to the first network interface and the second network interface.

11. The system according to claim 10, wherein the computer processor included in a programmable computer implemented switch module, causes the input switch module to further perform operations of: receiving, in the input switch module, the first plurality of signals from the second computer, transmitted over the computer network, wherein the at least one signal of the first plurality of signals indicates one of the current position state of display of the cursor being displayed on the second computer display screen when the switch position of the throw of the input switch changes to connect to the second device driver and the current position state of display of the cursor being displayed on the display screen of the first computer when the switch position of the throw of the input switch changes to connect to the first device driver, wherein the at least one input device is communicatively coupled to the second device driver through the third device driver, when the switch position of the throw of the input switch changes to connect to the second device driver.

12. The system according to claim 11, wherein the computer processor included in the input switch module, causes the input switch module to further perform operations of: transmitting, over the computer network, the third plurality of signals from the at least one input device to control application programs executing on the second computer, when the switch position of the throw of the input switch changes to connect to the second device driver.

13. A computer-readable medium having computer-executable instructions controlling a multi-display computer system using a seamless user interface, the computer-executable instructions executed by a computer processor causing the computer processor to perform a method comprising:
receiving, in an input switch, a first plurality of signals from a first network computer system and a second network computer system, wherein an at least one signal of the first plurality of signals indicates a current position state of display of a cursor being rendered on one of a standard display screen, associated with the first network computer system, and a display screen of the first network computer system and a display screen of the second network computer system, wherein the standard display screen, and the display screens of the first and second network computer systems are communicatively coupled to the first network computer system and the second network computer system, respectively, wherein the first network computer system includes a first device driver and the second network computer system includes a second device driver, wherein the standard display screen is a full resolution display required for scaling large numbers of a plurality of display screens that may be communicatively coupled to the first and second network computer systems, forming the multi-display system, and wherein the multi-display computer system includes a low resolution display screen embedded in one or more of the display screens of the first and the second network computer systems, wherein one or more of the display screens may operate at resolutions lower than the full resolution display;
receiving, from a third device driver a second plurality of signals from an at least one input device, wherein the third device driver is communicatively coupled to the input switch, and wherein the at least one input device is communicatively coupled to the third device driver;
receiving a first input signal of the second plurality of signals from the at least one input device, wherein position data change for the cursor associated with a first display of one or more displays, while the cursor moves in its rendering on a second display of one or more displays of the second network computer system, wherein the first input signal is one or more of an x-signal and a y-signal, conveying one of movement of a mouse and corresponding to movement of the cursor, wherein the first input signal from the second plurality of signals is relayed over a computer network to one of a first application display driver of the standard computer system, the first network computer system and a second application display driver of the second network computer system, and wherein the first input signal causes the cursor to change the current position state of display on one of the standard display screen, the first network computer display screen and the second network computer display screen and causes the cursor to move in a plurality of directions and traverse a plurality of distances on one or more of the standard display screen and the display screens of the first network computer system and the second network computer system;
changing, automatically, a switch position of the input switch to communicatively coupled to one of the first device driver and the second device driver, when the switch position of the input switch is used to determine that the current position state of display of the cursor reaches a predetermined boundary in the standard display screen of the first network computer system, and the display screen of the first network computer display and the second network computer, wherein the switch position determines coupling between the at least one input device and the first and second device drivers and between the at least one input device and the first and second network computer systems, wherein the predetermined boundary is a switching predicate of position states the cursor must satisfy in one of the first network computer system associated with the standard display screen, and a switching predicate of position states the cursor must satisfy in the second network computer system associated with the first and second network computer displays, in order for switching between the standard display screen, and the first and second network computer displays can be accomplished, and rendered as the cursor switching between the standard display screen, and the first and second network computer displays, wherein the switching predicate is computed on one of the first computer and the second computer, and the input switch, and wherein the input switch receives a switch signal when the switching predicate is satisfied, and wherein the input switch is in a null position, when the input switch does not receive the switch signal when the switching predicate is not satisfied and the cursor is not rendered on the display screen of the first network computer system and the network display screens of the second network computer system; and
performing one of simultaneously displaying and moving the cursor on one or more of the display screens of the second network computer system when the switch position of the input switch changes to connect to the second device driver and simultaneously displaying and moving the cursor on the standard display screen of the first network computer system when the switch position of the input switch changes to connect to the first device driver, thereby creating a seamless transition of the cursor rendering between the display screen of the first network computer system and one or more display screens of the second computer system.

14. The computer-readable medium controlling the multi-display computer system according to claim 13, wherein the input switch is included in one of the first network computer system and the second network computer system.

15. The computer-readable medium controlling the multi-display computer system according to claim 14, wherein the input switch is one of hardwired into one of the first network computer system and the second network computer system, and is a plug-in module plugged into one of the first network computer system and the second network computer system, and is a software module residing in a program memory of one of the first network computer system and the second network computer system.

16. The computer-readable medium controlling the multi-display computer system according to claim 15, wherein the first network computer system and the second network computer system include a first network interface and a second network interface respectively, and wherein the first network computer system and the second network computer system are communicatively coupled over the computer network connected to the first network interface and the second network interface.

17. The computer-readable medium controlling the multi-display computer system according to claim 13, wherein the computer-executable instructions executed by the computer processor causing the computer processor to perform the method further comprising receiving, in the input switch, the first plurality of signals from the second network computer system, wherein the first plurality of signals is transmitted over the computer network, wherein the at least one signal of the first plurality of signals indicates one of the current position state of display of the cursor being displayed on the display screen of the second network computer when the switch position of the input switch changes to connect to the second device driver and the current position state of display of the cursor being displayed on the display screen of the first network computer when the switch position of the input switch changes to connect to the first device driver, and wherein the at least one input device is communicatively coupled to the second device driver through the third device driver, when the switch position of the input switch changes to connect to the second device driver.

18. The computer-readable medium controlling the multi-display computer system according to claim 13, wherein the computer-executable instructions executed by the computer processor causing the computer processor to perform the method further comprising transmitting over the computer network a third plurality of signals from the at least one input device to control application programs executing on the second network computer, when the switch position of the input switch changes to connect to the second device driver.

19. The computer-readable medium controlling the multi-display computer system according to claim 13, wherein functionality of the first network computer system and the functionality of the second network computer system are rendered in a single network computer system and wherein components of the multi-display computer system are icons, text and static data conveyed over the computer network during setup, or periodic samples of the displays.

20. The computer-readable medium controlling the multi-display computer system according to claim 19, wherein, in response to receiving a signal selected from a user of the multi-display computer system, computer-executable instructions cause the cursor to move through the plurality of network computer system display screens operating at resolutions lower than the full resolution display and selects an at least one of the plurality of network computer display screens, wherein selecting the at least one of the plurality of network computer display screens causes an output of the at least one of the plurality of network computer display screens to be input to and displayed on the full resolution display, wherein selecting includes one or more of clicking and right clicking and highlighting and zooming on an image in the at least one of the plurality of network computer display screens, wherein the output is a real-time image, and wherein the cursor moves seamlessly between the multi-display and the full resolution display.
